(19) United States
(12) Patent Application Publication
(10) Pub. No.: US 2005/0057162 A1
(43) Pub. Date: Mar. 17, 2005

(54) System to control the luminosity and extend the life of motor vehicle lights

(76) Inventors: Joseph Kover JR., Layton, UT (US); Joseph David Kover, Kaysville, UT (US)

Correspondence Address: Joseph Kover, Jr., 974 North Aspen Way, Layton, UT, 84040, US

(21) Appl. No.: 10/662,234

(22) Filed: Sep. 15, 2003

(51) Int. Cl. H05B 37/02

(52) U.S. Cl. 315/77; 315/82

(57) ABSTRACT

The present invention relates to a system to control the luminosity and extend the life of the motor vehicle lghts. The present invention can further be extended to where the motor vehicle lights are progressively increased as the current ambient light conditions or the current visibility conditions decrease and progressively decreased as the current ambient light conditions or the current visibility conditions.

### BACKGROUND OF THE INVENTION

The present invention relates to a system that controls the luminosity and extends the life of the motor vehicle lights. The application to control the luminosity of the motor vehicle headlights is widely used where the conventional headlights serve in a dual capacity. During the hours from dawn to dusk the headlights operate in the daytime running light mode, at a reduced luminous level, whereas during the hours from dusk to dawn the headlights operate in the normal mode, at the full luminous level. This application can further be extended to where the motor vehicle lights are progressively increased as the current ambient light conditions or the current visibility conditions decrease and progressively decreased as the current ambient light conditions or the current visibility conditions increase. The application can also be extended to include the rear fog lights during low visibility conditions.

Furthermore, the application of the present invention can also be collectively extended to prolong the life of the motor vehicle lights with the exception of the turn signal lights and emergency flasher lights. The majority of the motor vehicle lights fail during the initial power up phase. The reason for these failures is because during the power up phase, when a light filament is cold, the impedance is considerably less than a light filament that has attained a normal operating temperature. Consequently, the initial surge current through a cold light filament is significantly greater than the current through a light filament that has attained a normal operating temperature. Accordingly, the surge currents that occur during the initial power up phase weaken and eventually destroy the light filament. The present invention also serves to eliminate the detrimental current surges and the transients that are introduced during the initial power up phase and during the load-switching phase.

The application to control the luminosity of the motor vehicle headlights is widely used where the conventional headlights serve in a dual capacity. Hagg and Schlaps submit a system for vehicle daytime running lamps (U.S. Pat. No. 4,684,819 issued to Ronald H. Haag and Edgar H. Schlaps in August, 1987), while a second submits a daytime running light system (U.S. Pat. No. 5,081,565 issued to Ali M Nabha and Michael C. Long in January, 1992). A third system submits a motor vehicle daytime running light system having buckswitch mode converter (U.S. Pat. No. 5,646,485 issued to John David Simon, Michael Joseph Dreon, William Lee Small, Pierre Youssef Abboudd, and Brian Douglas Pasha in July, 1997). The first two systems (U.S. Pat. No. 4,684,819 and U.S. Pat. No. 5,081,565) have been proven to significantly reduce the life of the motor vehicle headlights, while all three systems introduce another potential common impediment. The common impediment to all three systems relates to the oscillator, whereby should the oscillator experience a drift in frequency the headlights could either begin to pulsate, interpose an undesirable electrical noise onto the motor vehicle's electrical system, or inadvertently vary the luminosity of the headlights. An additional disadvantage to all three systems is that these embodiments fail to address the normalized on resistance versus temperature characteristics of the current/voltage control devices, whereby a dynamic increase in the junction temperature, effectuated by the power that is dissipated by the current/voltage control device, precipitates a corresponding dynamic increase in the on resistance. The dynamic increase in the on resistance initiates a corresponding dynamic decrease in the luminosity of the motor vehicle lights which is disadvantageous in applications where the luminosity of motor vehicle lights operate at a reduced luminous level, such as daytime running light systems or adverse weather rear light systems. Furthermore, these technologies fail to control the initial power up current surges in both the daytime running light reduced luminous mode and in the normal full luminous mode when the light filament is cold and the impedance of the light filament is considerably less than a light filament that has attained a normal operating temperature. Tsutomu submits an electrical system for vehicle daytime running lights (U.S. Pat. No. 4,841,199 issued to Tsutomu Irie in June, 1989), while a second system submits an electrical system for vehicle daytime running lights (U.S. Pat. Re. 34,886 issued to Tsutomu Irie in March, 1995). The disadvantage of these two systems is that if one headlight should fail then the motor vehicle would lose the use of all headlights, even during normal headlight operation. Furthermore, these technologies also fail to control the initial power up current surges in both the daytime running light reduced luminous mode and in the normal full luminous mode when the light filament is cold and the impedance of the light filament is considerably less than a light filament that has attained a normal operating temperature. An alternate system submits a simplified automatic energy saving for automotive daytime running lights (U.S. Pat. No. 5,705,893 issued to Donald F. Oberg in January, 1998) while a second system submits daytime running lights (U.S. Pat. No. 5,780,974 issued to Parmjit S. Pabla and Merrill D. Miller in July, 1998). The first system claims a simplified automatic energy saving for automotive daytime running lights. However, since the resistor in the path of conduction dissipates a large amount of power, in the form of heat, this system negates any purported energy savings. Furthermore, these technologies also fail to control the initial power up current surges in both the daytime running light reduced luminous mode and in the normal full luminous mode when the light filament is cold and the impedance of the light filament is considerably less than a light filament that has attained a normal operating temperature. Kobayashi (U.S. Pat. No. 6,254,259 issued to Shoji Kobayashi in July, 2001) submits a system for the illumination control of motor vehicle lamps. However, this technology employs shields and reflective mirrors which is extremely complex and expensive. Furthermore, this technology also fails to control the initial power up current surges in both the daytime running light reduced luminous mode and in the normal full luminous mode when the light filament is cold and the impedance of the light filament is considerably less than a light filament that has attained a normal operating temperature. The application of this system introduces an additional restriction in that it is limited to motor vehicle lights that incorporate halogen and/or incandescent light bulbs and proves ineffective with motor vehicle lights that incorporate the recently introduced motor vehicle lights that consists of light emitting diodes (LEDs).

### SUMMARY OF THE INVENTION

The present invention relates to a system that controls the luminosity and extends the life of the motor vehicle lights. The application to control the luminosity of the motor vehicle headlights is widely used where the conventional headlights serve in a dual capacity. During the hours from dawn to dusk the headlights operate in the daytime running light mode, at a reduced luminous level, whereas during the hours from dusk to dawn the headlights operate in the normal mode, at the full luminous level. This application can further be extended to where the motor vehicle lights are progressively increased as the current ambient light conditions or the current visibility conditions decrease and progressively decreased as the current ambient light conditions or the current visibility conditions increase. The application can also be extended to include the rear fog lights during low visibility conditions.

Furthermore, the application of the present invention can also be collectively extended to prolong the life of the motor vehicle lights with the exception of the turn signal lights and emergency flasher lights. The majority of the motor vehicle lights fail during the initial power up phase. The reason for these failures is because during the power up phase, when the light filament is cold, the impedance is considerably less than a light filament that has attained a normal operating temperature. Consequently, the initial surge current through a cold light filament is significantly greater than the current through a light filament that has attained a normal operating temperature. Accordingly the surge currents that occur during the initial power up phase weaken and eventually destroy the light filament. The present invention also serves to eliminate the detrimental current surges and the transients that are introduced during the initial power up phase and during the load-switching phase.

The preferred embodiment of the system to control the luminosity and extend the life of the motor vehicle lights is comprised of a digital sequencing device, a drive circuit device, and a current/voltage limiting device such as bipolar transistors or metal oxide semiconductor field effect transistors. In addition the embodiment also includes a means to measure the DC current through the motor vehicle lights and the adverse weather rear lights and/or the DC voltage across the motor vehicle lights and the adverse weather rear lights to negate the normalized on resistance versus temperature characteristics of the current/voltage control devices and the varying impedance of the light source, which is disadvantageous in applications where the luminosity of motor vehicle lights operate at a reduced luminous level. In the reduced luminous state, the digital sequencing device applies a preprogrammed digital value to the drive circuit device. The drive circuit device converts the digital value to an analog voltage level. The resulting analog voltage level is then be applied to the current/voltage limiting device that is placed between the power source and the motor vehicle light source which serves to control the current that appears through the light source, the voltage that appears across the light source, and the luminosity of the light source. The means to measure the DC current through the motor vehicle lights and the adverse weather rear lights and/or the DC voltage across the motor vehicle lights and the adverse weather lights further serves to facilitate the alteration of the luminosity levels of the motor vehicle lights and the adverse weather rear lights. Whereby shifting the values for the DC current through the motor vehicle lights and/or the DC voltage across the motor vehicle lights enables the system to satisfy a multiplicity of requirements. Furthermore, the means to measure the DC current through the headlights, the adverse weather rear lights, or any other motor vehicle lights and/or the DC voltage across the headlights, the adverse weather rear light, or any other motor vehicle lights also serves to negate the normalized on resistance versus the temperature characteristics of the current/voltage control devices and the varying impedance of the light source, and activate a fault indicator if the current/voltage level is either greater than or less than the programmed current/voltage level where the luminosity of motor vehicle lights operate at a reduced luminous level. The current/voltage measurement means activates a fault indication means if the voltage level is either greater than or less than the programmed voltage level

The embodiment, to establish the state of the vehicle, also includes a means to collect, receive, and combine the data from the vehicle such as the state of the light switch, whether activated manually or automatically, the park brake switch, or the transmission park/neutral safety switch. The motor vehicle headlights operate either in the reduced luminous daytime running light mode or in the full luminous normal mode based upon the preprogrammed vehicle state. Furthermore, the data that is received from the vehicle can also be extended to include such information as current ambient light conditions, current visibility conditions, the state of the windshield wiper switch, or any other condition required to establish the state of the vehicle.

The application of the invention can further be extended to prolong the life of the motor vehicle lights. This embodiment stores, in ROM, a digital sequence and the time interval that the digital sequence either increments or decrements. In addition, the time interval between when the digital sequence either increments or decrements can be of one value for t=0 to t=1, a second value at t=1 to t=2, and a third value at t=2 to t=3. During the initial power up phase when the light filament is cold the digital sequencing device, the drive circuit device, and the current/voltage limiting device controls the rate of change of the DC current through a light filament and/or the DC voltage across a light filament, which serves to eliminate the surge currents that occur during the initial power up phase. Once the light filament attains the normal operating temperature, the digital sequencing device maintains the preprogrammed digital value to the drive circuit device. The drive circuit device converts the digital value to an analog voltage level, applies the resulting analog voltage level to the current/voltage limiting device, and controls the luminosity of the headlights or any other motor vehicle lights. The means to measure either the DC current through the headlights, the adverse weather rear lights, or any other motor vehicle lights and/or the DC voltage across the headlights, the adverse weather lights, or any other motor vehicle lights serves to negate the normalized on resistance versus the temperature characteristics of the current/voltage control devices, whereby a dynamic increase in the junction temperature, effectuated by the power that is dissipated by the current/voltage control device, precipitates a corresponding dynamic decrease in the on resistance, and maintains the luminosity of the headlights or any other motor vehicle lights at an unvarying level. Furthermore, the application of the present invention can also be collectively extended to control any DC load of the motor vehicle and eliminate the detrimental current surges and the transients that are introduced during the initial power up phase and the load-switching phase.

### BRIEF DESCRIPTION OF THE DRAWINGS

FIG. 1A is the circuit diagram, according to the present invention, that illustrates the inputs to the logic level down converter which includes the motor vehicle headlight switch, the low beam and the high beam headlight switch, the trigger switch (the park brake switch or the transmission park/neutral safety switch), the fog light switch, the tail/park light switch, and the ignition switch.

FIG. 1B is the circuit diagram, according to the present invention, that illustrates the inputs from the logic level down converter to the digital sequencing device, the digital output from the digital sequencing device to the digital input of the drive circuit device, and the analog output from the drive circuit device to the current/voltage limiting device. The circuit diagram further illustrates the connections from, the motor vehicle light switch and the current/voltage limiting device.

FIG. 2A is the circuit diagram, according to the present invention, that illustrates the inputs to the logic level down converter which includes the motor vehicle headlight switch, the low beam and the high beam headlights switch, the trigger switch (the park brake switch or the transmission park/neutral safety switch), the fog light switch, the tail/park light switch, and the ignition switch.

FIG. 2B is the circuit diagram, according to the present invention, that illustrates the inputs from the logic level down converter to the digital sequencing device, the digital output from the digital sequencing device to the digital input of the drive circuit device, and the analog output from the drive circuit device to the current/voltage limiting device. The circuit diagram further illustrates the connections from, the motor vehicle light switch and the current/voltage limiting device where the current/voltage limiting device.

FIG. 3 is the circuit diagram, according to the present invention, that illustrates the inputs from the logic level down converter, FIG. 2A, to the digital sequencing device, the digital output from the digital sequencing device to the digital input of the drive circuit devices, and the analog output from the drive circuit devices to current/voltage limiting devices. The circuit diagram further illustrates the connections from, the motor vehicle light switch.

FIG. 4 is the circuit diagram, according to the present invention, that illustrates the digital inputs from the digital sequencing device to the digital input of the drive circuit device and the analog output from the drive circuit device to the current/voltage limiting device. The circuit diagram also illustrates the implementation of the invention where bipolar junction transistors serve to control the current that appears through the motor vehicle headlights and the voltage that appears across motor vehicle headlights.

FIG. 5 is the circuit diagram, according to the present invention, that illustrates the digital inputs from the digital sequencing device to the digital input of the drive circuit device and the analog output from the drive circuit device to the current/voltage limiting devices. The circuit diagram further illustrates where parallel metal oxide semiconductors field effect transistors serve to control the current that appears through the motor vehicle headlights and the voltage that appears across the motor vehicle headlights.

FIG. 6A is the first section of the general flow chart of the program logic that illustrates the daytime running light embodiment of the invention.

FIG. 6B is the second section of the general flow chart of the program logic that illustrates the daytime running light embodiment of the invention.

FIG. 6C is the third section of the general flow chart of the program logic that illustrates the daytime running light embodiment of the invention.

FIG. 7A is the circuit diagram, according to the present invention, that illustrates the connections from the output of the digital sequencing device to the digital input of the drive circuit devices, from the analog output of the drive circuit devices to the current/voltage limiting devices, from the ambient light detector to digital to analog converter, and from the visibility detector to the digital to analog converter. The circuit diagram also illustrates the connections between the digital sequencing devices, the drive circuit devices, and the current/voltage limiting devices that controls the luminosity of the tail/park lights, the adverse weather rear lights (rear fog lights), the high beam headlights, and the low beam headlights.

FIG. 7B is the first section of the general flow chart of the program logic that illustrates the ambient light and current visibility embodiment of the invention.

FIG. 7C is the second section of the general flow chart of the program logic that illustrates the ambient light and current visibility embodiment of the invention.

FIG. 7D is the third section of the general flow chart of the program logic that illustrates the ambient light and current visibility embodiment of the invention.

FIG. 7E is the fourth section of the general flow chart of the program logic that illustrates the ambient light and current visibility embodiment of the invention.

FIG. 7F is the fifth section of the general flow chart of the program logic that illustrates the current visibility embodiment of the invention.

FIG. 7G is the sixth section of the general flow chart of the program logic that illustrates the current visibility embodiment of the invention.

FIG. 8 is the general flow chart of the program logic that illustrates the control of the initial surge currents through the light filaments during the initial power up phase.

FIG. 9A is the circuit diagram, according to the present invention, that illustrates the negation of the normalized on resistance versus the temperature characteristics of the current/voltage control devices, the digital inputs from the digital sequencing device to the digital input of the drive circuit device, and the analog output from the drive circuit device to the current/voltage limiting device. The circuit diagram further illustrates the current measurement and the voltage measurement devices from the headlights and the adverse weather rear lights to the multi-channel analog to digital converter.

FIG. 9B is the general flow chart of the program logic that illustrates the negation of the normalized on resistance versus the temperature characteristics of the current/voltage control devices and maintain the luminosity of the headlights or any other motor vehicle lights at an unvarying level.

### DETAILED DESCRIPTION OF THE PREFERRED EMBODIMENTS

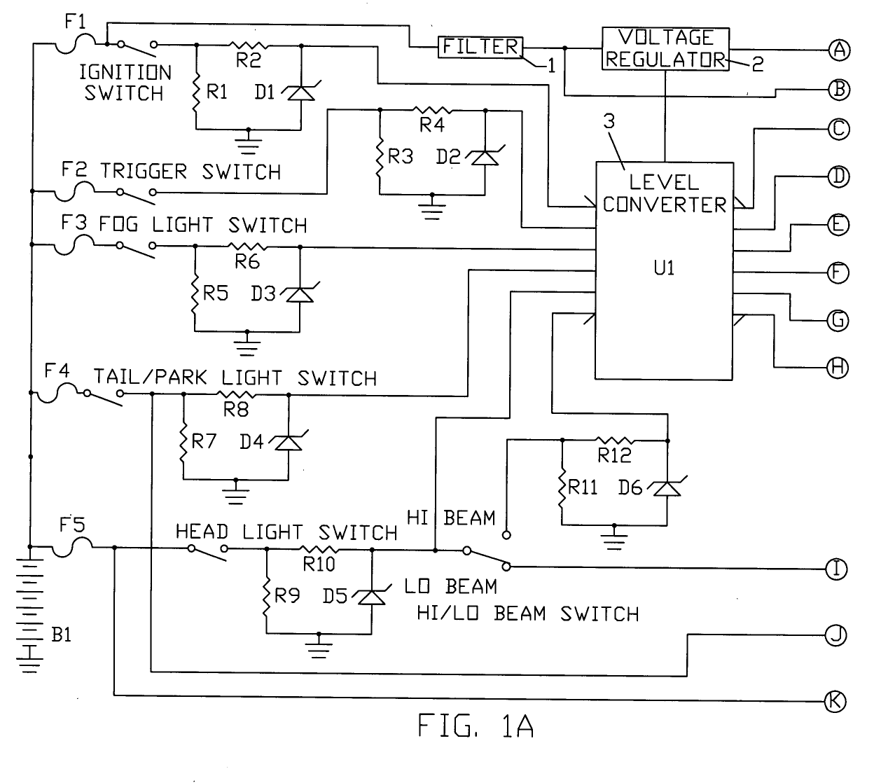

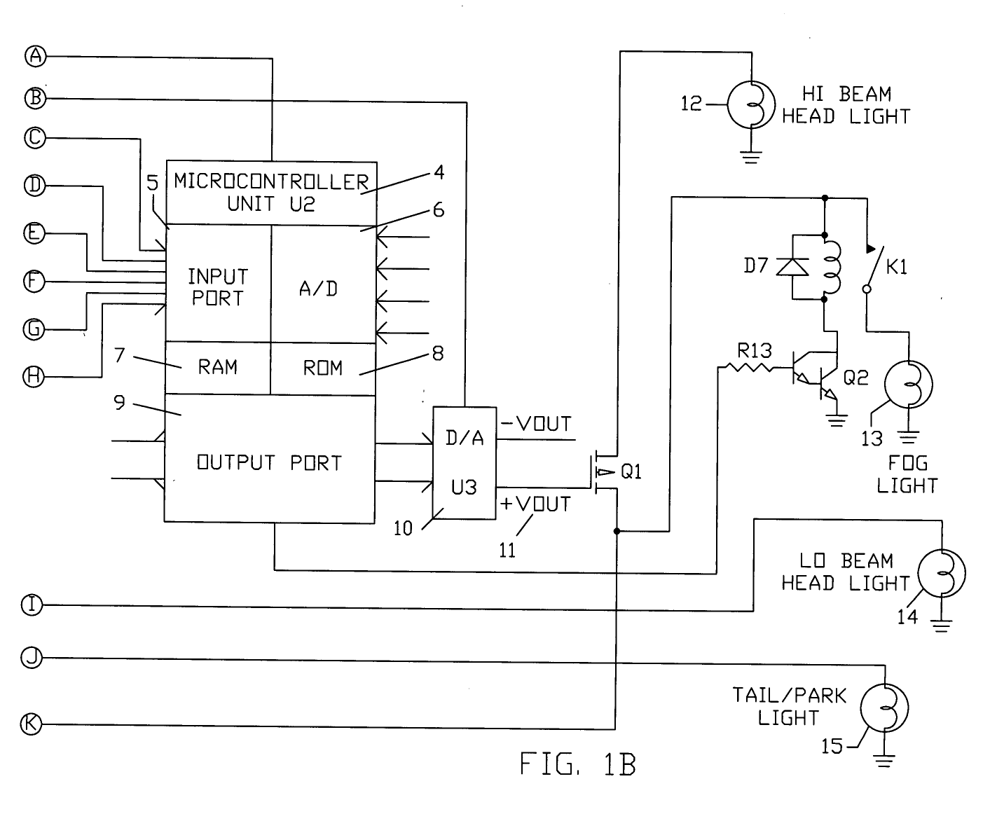

The drawings shown in FIGS. 1A, 1B, 2A, 2B, 3, 4, 5, 6A through 6C, 7A through 7G, 8, 9A, and 9B for the preferred embodiments of the system to control the luminosity and extend the life of the motor vehicle lights will now be addressed in complete detail.

FIG. 1A is the schematic diagram, according to the present invention, that illustrates the vehicle battery B1, the inputs to the logic level down converter 3 which are comprised of the motor vehicle headlight switch, the high beam headlight switch, the trigger switch (the park brake switch or the transmission park/neutral safety switch), the fog light switch, the tail/park light switch, the ignition switch, and the corresponding fuses that protect the vehicle electrical system from an over current condition. Furthermore, additional inputs, such as the windshield wiper switch may be included to further establish the state of the vehicle. FIG. 1A further illustrates the reversed battery and over voltage protection circuit 1, the voltage regulator 2, the resistor diode filter networks that protect the inputs to the logic level down converter 3, and the outputs A through K to the corresponding inputs A through K of FIG. 1B. The vehicle battery B1 supplies current to the ignition switch, the trigger switch, the fog light switch, the tail/park light switch, the headlight switch, the reversed battery and over voltage protection circuit 1, which supplies current to the voltage regulator 2 and to output B. The voltage regulator 2 supplies five volts to the logic level down converter 3 and to output A. The resistors R1, R3, R5, R7, R9, and R1 in combination with R2, R4, R6, R8, R10, and R12 serve as pull down resistors to the inputs of the logic level down converter 3. The resistors R2, R4, R6, R8, R10, and R12 in combination with zener diodes D1, D2, D3, D4, D5, and D6 serve to protect the inputs of the logic level down converter from voltage and current transients. The logic level down converter 3 converts the motor vehicle headlight switch, the high beam headlight switch, the trigger switch (the park brake switch or the transmission park/neutral safety switch), the fog light switch, the tail/park light switch, and the ignition switch from approximately twelve volts to a logic level of either five volts when the switch is in a closed state or zero volts when the switch is in an open state.

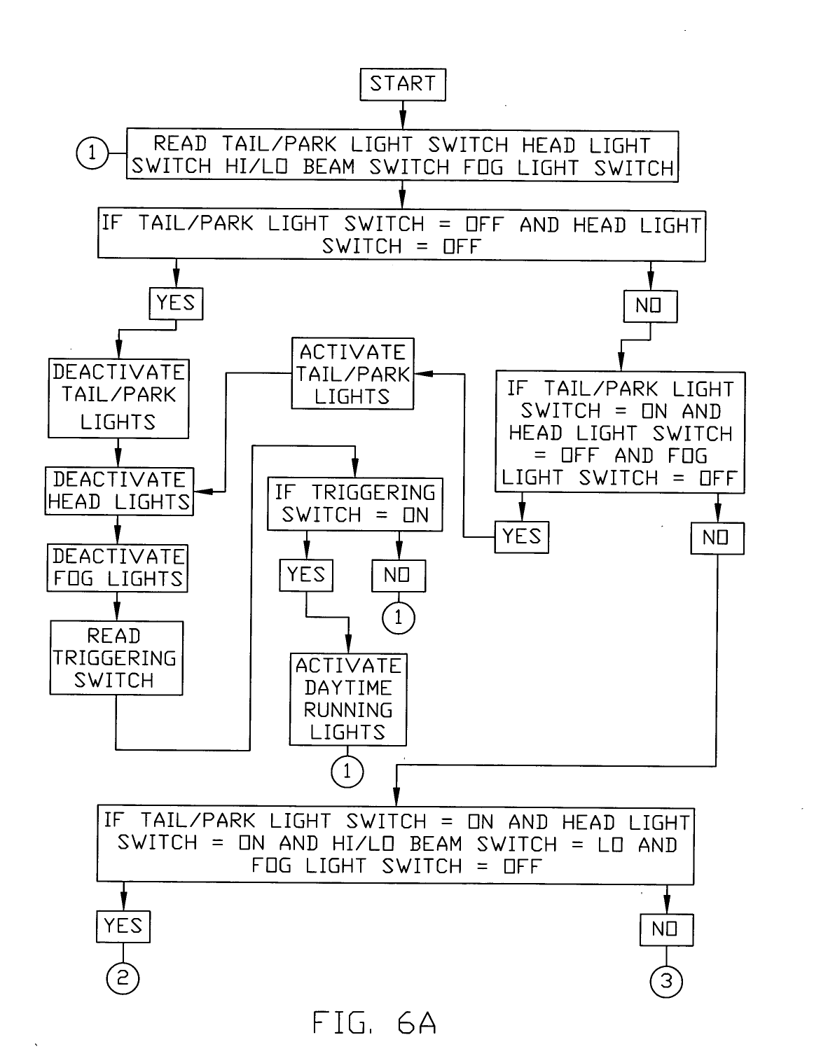

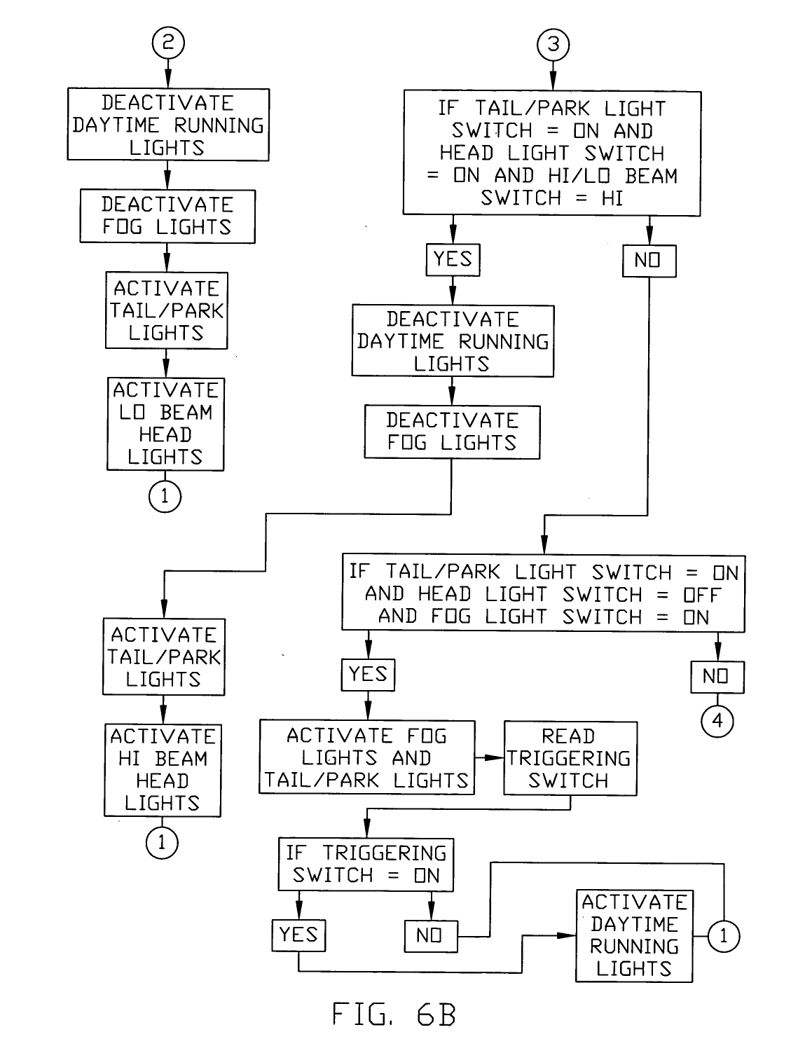

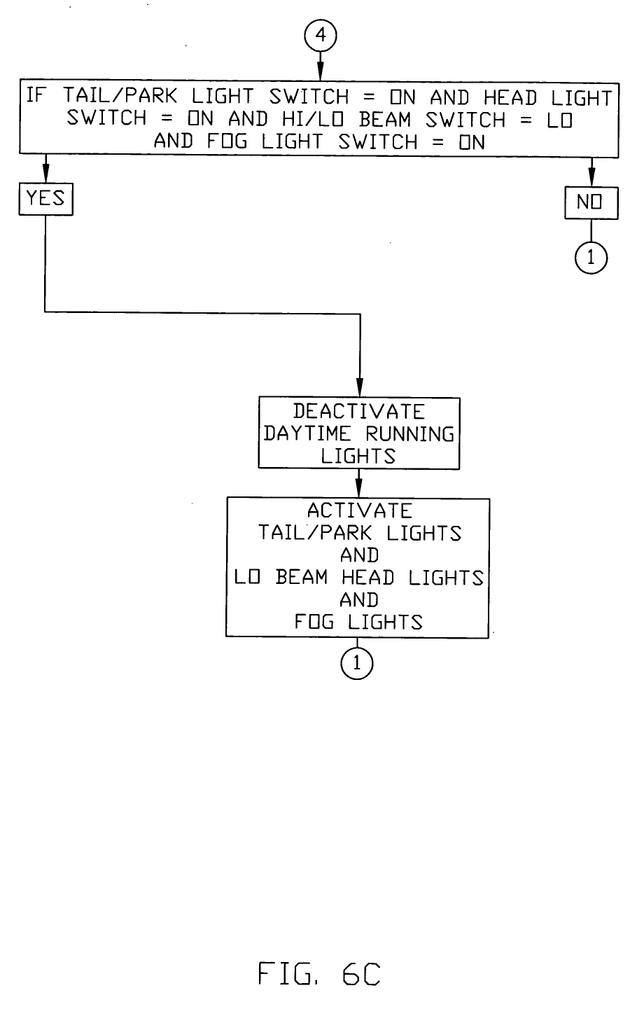

FIG. 1B is the second schematic diagram, according to the present invention, that illustrates the microcontroller unit 4 and includes an onboard input port 5, onboard RAM 7, onboard ROM 8, where the control programs of FIGS. 6A through 6C, 7B through 7G, 8, and 9B are permanently resident, an onboard output port 9, and an onboard multi-channel analog to digital converter 6. FIG. 1B further illustrates a multi-channel digital to analog converter 10 with a positive output voltage terminal 11, the current/voltage control device Q1, the fog light drive circuit comprised of K1, D7, R13, and Q2, the high beam headlights 12, the low beam headlights 14, the tail/park lights 15, the fog lights 13, and the inputs A through K from the corresponding inputs A through K of FIG. 1A. Input A supplies five volts, from the voltage regulator 2 of FIG. 1A, to the microcontroller unit 4 while input B supplies approximately twelve volts from the reversed battery and over voltage protection circuit 1 of FIG. 1A to the multi-channel digital to analog converter 10. Inputs C through H represent the corresponding digital five-volt or zero-volt outputs, from the logic level down converter 3 of FIG. 1A, and serve to establish the state of the vehicle. The microcontroller unit 4 serves to receive, combine, and process, by means of the input port 5, the current state of the vehicle. Input I is the corresponding output I, from FIG. 1A, to the low beam headlights, input J is the corresponding output J, from FIG. 1A, to the tail/park lights, while input K is the corresponding output K, from FIG. 1A, to the current/voltage control device Q1, the fog light relay K1, and to the fog lights 13. FIG. 1B also illustrates where the life of the motor vehicle headlights can be extended by a preprogrammed digital sequence that either increments or decrements at a given time interval and is applied to the multi-channel digital to analog converter 10. The multi-channel digital to analog converter 10 converts the digital sequence to a corresponding analog voltage level. The resulting analog voltage level is then applied, by means of the positive out voltage terminal 11 of the multi-channel digital to analog converter 10, to the current/voltage limiting device Q1 that is placed between the motor vehicle power source and the high beam headlights. The current/voltage limiting device Q1, in turn, controls the rate of change of the DC current through the headlights and the DC voltage across the headlights, which eliminates the surge currents that occur during the initial power up phase. FIG. 1B also illustrates where the luminosity of the high beam headlights is controlled by a preprogrammed digital value that is applied to the multi-channel digital to analog converter 10 by means of the output port 9. The multi-channel digital to analog converter 10 converts the digital value to a corresponding analog voltage level. The resulting analog voltage level is then applied, by means of the positive out voltage terminal 11 of the multi-channel digital to analog converter, to the current/voltage limiting device Q1 that is placed between the motor vehicle power source and the high beam headlights. The current/voltage limiting device Q1 serves to controls the current that appears through the high beam headlights and the voltage that appears across the high beam headlights and, in turn, controls the luminosity of the high beam headlights.

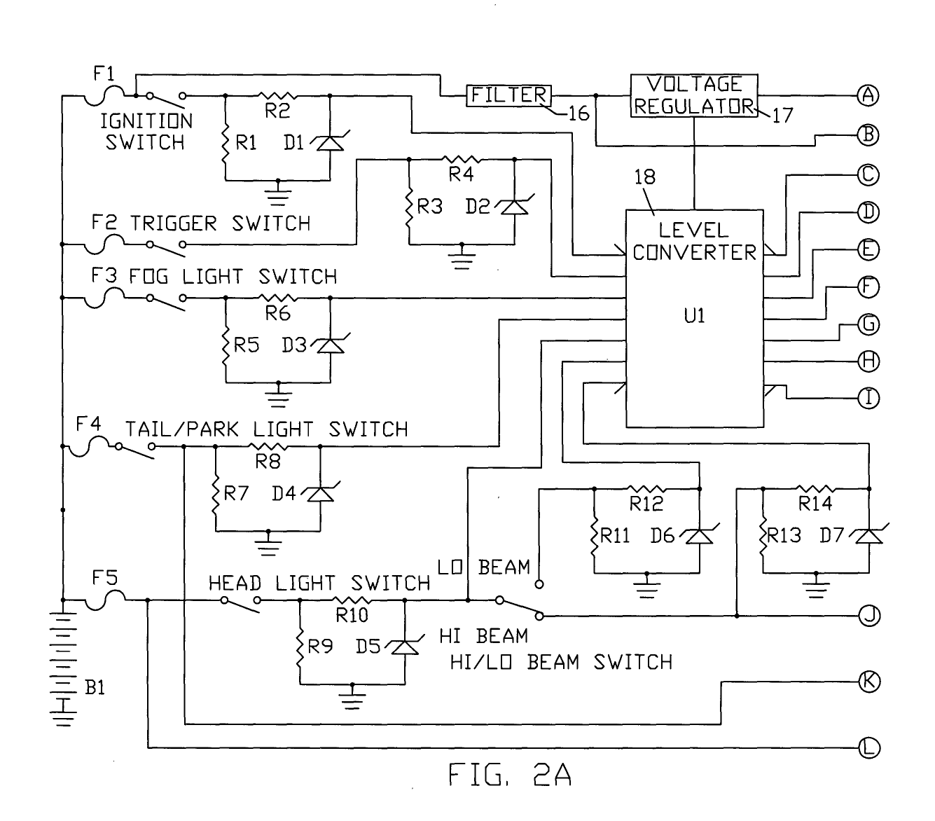

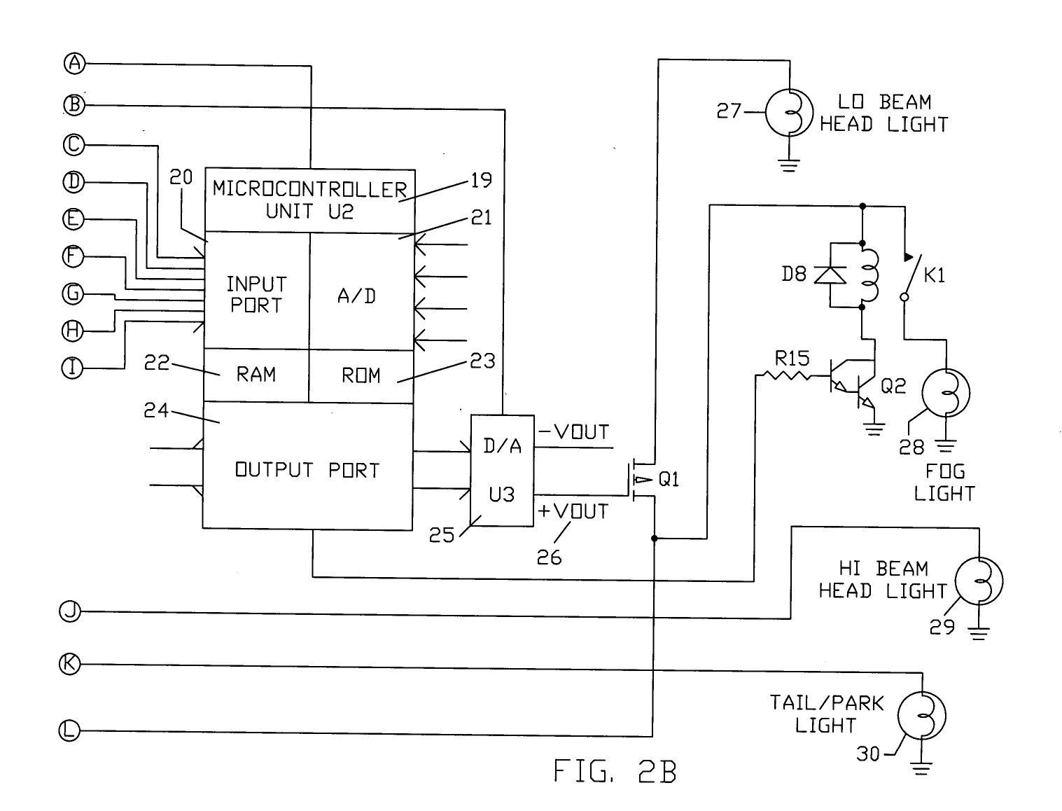

FIG. 2A is the schematic diagram, according to the present invention, that illustrates the vehicle battery B1, the inputs to the logic level down converter 18 which are comprised of the motor vehicle headlight switch, the low beam and the high beam headlight switch, the trigger switch (the park brake switch or the transmission park/neutral safety switch), the fog light switch, the tail/park light switch, the ignition switch, and the corresponding fuses that protect the vehicle electrical system from an over current condition. Furthermore, additional inputs, such as the windshield wiper switch may be included to further establish the state of the vehicle. FIG. 2A further illustrates the reversed battery and over voltage protection circuit 16, the voltage regulator 17, the resistor diode filter networks that protect the inputs to the logic level down converter 18, and the outputs A through L to the corresponding inputs A through L of FIG. 2B. The vehicle battery B1 supplies current to the ignition switch, the trigger switch, the fog light switch, the tail/park light switch, the headlight switch, the reversed battery and over voltage protection circuit 16, which supplies current to the voltage regulator 17 and to output B. The voltage regulator 17 supplies five volts to the logic level down converter 18 and to output A. The resistors R1, R3, R5, R7, R9, R11, and R13 in combination with R2, R4, R6, R8, R10, R12, and R14 serve as pull down resistors to the inputs of the logic level down converter 18. The resistors R2, R4, R6, R8, R10, R12, and R14 in combination with zener diodes D1, D2, D3, D4, D5, D6, and D7 serve to protect the inputs of the logic level down converter from voltage and current transients. The logic level down converter 18 converts the motor vehicle headlight switch, the low beam and the high beam headlight switch, the trigger switch (the park brake switch or the transmission park/neutral safety switch), the fog light switch, the tail/park light switch, and the ignition switch from approximately twelve volts to a logic level of either five volts when the switch is in a closed state or zero volts when the switch is in an open state.

FIG. 2B is the second schematic diagram, according to the present invention, that illustrates the microcontroller unit 19 and includes an onboard input port 20, onboard RAM 22, onboard ROM 23 where the control programs of FIGS. 6A through 6C, 7B through 7G, 8, and 9B are permanently resident, an onboard output port 24, and an onboard multi-channel analog to digital converter 21. FIG. 2B further illustrates a multi-channel digital to analog converter 25 with a positive output voltage terminal 26, the current/voltage control device Q1, the fog light drive circuit comprised of K1, D8, R15, and Q2, the high beam headlights 29, the low beam headlights 27, the tail/park lights 30, the fog lights 28, and the inputs A through L from the corresponding inputs A through L of FIG. 2A. Input A supplies five volts, from the voltage regulator 17 of FIG. 2A to the microcontroller unit 19 while input B supplies approximately twelve volts from the reversed battery and over voltage protection circuit 16 of FIG. 2A to the multi-channel digital to analog converter 25. Inputs C through I represent the corresponding digital five-volt or zero-volt outputs from the logic level down converter 18 of FIG. 2A and serve to establish the state of the vehicle. The microcontroller unit 19 serves to receive, combine, and process, by means of the input port 20, the current state of the vehicle. Input J is the corresponding output J, from FIG. 2A, to the high beam headlights, input K is the corresponding output K, from FIG. 2A, to the tail/park lights, while input L is the corresponding output L, from FIG. 2A, to the current/voltage control device Q1, the fog light relay K1, and to the fog lights 28. FIG. 2B also illustrates where the life of the motor vehicle headlights can be extended by a preprogrammed digital sequence that either increments or decrements at a given time interval and is applied to the multi-channel digital to analog converter 25. The multi-channel digital to analog converter 25 converts the digital sequence to a corresponding analog voltage level. The resulting analog voltage level is then applied, by means of the positive out voltage terminal 26 of the multi-channel digital to analog converter 25, to the current/voltage limiting device Q1 that is placed between the motor vehicle power source and the low beam headlights. The current/voltage limiting device Q1, in turn, controls the rate of change of the DC current through the headlights and the DC voltage across the headlights, which eliminates the surge currents that occur during the initial power up phase. FIG. 2B also illustrates where the luminosity of the low beam headlights is controlled by a preprogrammed digital value that is applied to the multi-channel digital to analog converter 25 by means of the output port 24. The multi-channel digital to analog converter 25 converts the digital value to a corresponding analog voltage level. The resulting analog voltage level is then applied, by means of the positive out voltage terminal of the multi-channel digital to analog converter 26, to the current/voltage limiting device Q1 that is placed between the motor vehicle power source and the low beam headlights. The current/voltage limiting device Q1 serves to control the current that appears through the low beam headlights and the voltage that appears across the low beam headlights and, in turn, controls the luminosity of the low beam headlights.

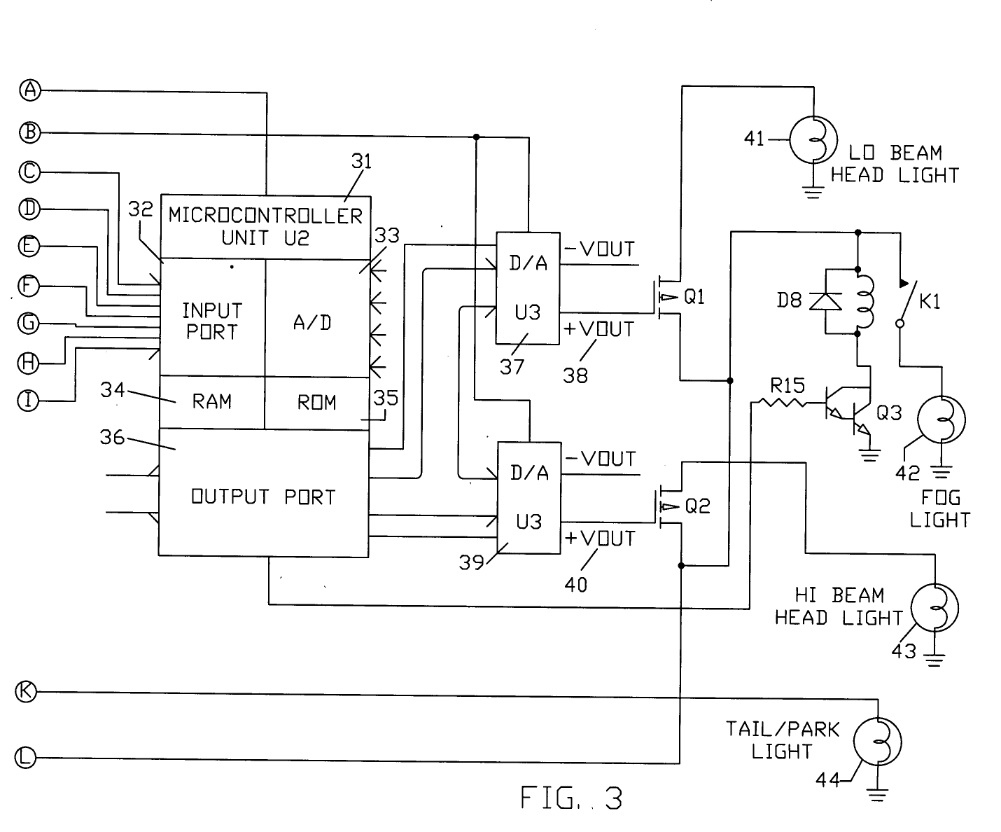

FIG. 3 is the schematic diagram, according to the present invention, that illustrates the microcontroller unit 31 and includes an onboard input port 32, onboard RAM 34, onboard ROM 35 where the control programs of FIGS. 6A through 6C, 7B through 7G, 8, and 9B are permanently resident, an onboard output port 36, and an onboard multi-channel analog to digital converter 33. FIG. 3 further illustrates a multi-channel digital to analog converter 37 and 39 with positive output voltage terminals 38 and 40, the current/voltage control devices Q1 and Q2, the fog light drive circuit comprised of K1, D8, R15, and Q3, the high beam headlights 43, the low beam headlights 41, the tail/park lights 44, the fog lights 42, and the inputs A through I, K, and L from the corresponding inputs A through I, K, and L of FIG. 2A. Input A supplies five volts, from the voltage regulator 17 of FIG. 2A to the microcontroller unit 31 while input B supplies approximately twelve volts from the reversed battery and over voltage protection circuit 16 of FIG. 2A to the multi-channel digital to analog converters 37 and 39. Inputs C through I represent the corresponding digital five-volt or zero-volt outputs from the logic level down converter 18 of FIG. 2A and serves to establish the state of the vehicle. The microcontroller unit 31 serves to receive, combine, and process, by means of the input port 32, the current state of the vehicle. Input J is eliminated since the activation and deactivation of the high beam headlights has become a function of the multi-channel digital to analog converter 39, the positive output voltage terminal 40, and Q2. Input K is the corresponding output K, from FIG. 2A, to the tail/park lights, while input L is the corresponding output L, from FIG. 2A, to the current/voltage control devices Q1, Q2, the fog light relay K1, and to the fog lights 42. FIG. 3 also illustrates where the life of the motor vehicle headlights can be extended by a preprogrammed digital sequence that either increments or decrements at a given time interval and is applied to the multi-channel digital to analog converters 37 and 39 by means of the output port 36. The multi-channel digital to analog converters 37 and 39 convert the digital sequence to corresponding analog voltage levels. The resulting analog voltage levels are then applied, by means of the positive out voltage terminals 38 and 40 of the multi-channel digital to analog converters 37 and 39, to the current/voltage limiting devices Q1 and Q2 which are placed between the motor vehicle power source and the low beam and the high beam headlights. The current/voltage limiting devices Q1 and Q2, in turn, control the rate of change of the DC current through the headlights and the DC voltage across the headlights, which eliminates the surge currents that occur during the initial power up phase. FIG. 3 further illustrates where the luminosity of the headlights is controlled by a preprogrammed digital value that is applied to the multi-channel digital to analog converters 37 and 39 by means of the output port 36. The multi-channel digital to analog converters 37 and 39 convert the digital values to corresponding analog voltage levels. The resulting analog voltage levels are then applied, by means of the positive out voltage terminals 38 and 40 of the multi-channel digital to analog converters 37 and 39, to the current/voltage limiting devices Q1 and Q2 that are placed between the motor vehicle power source and the low beam and the high beam headlights. The current/voltage limiting devices Q1 and Q2 serve to control the current that appears through the headlights and the voltage that appears across the headlights and, in turn, controls the luminosity of either the high beam or the low beam headlights.

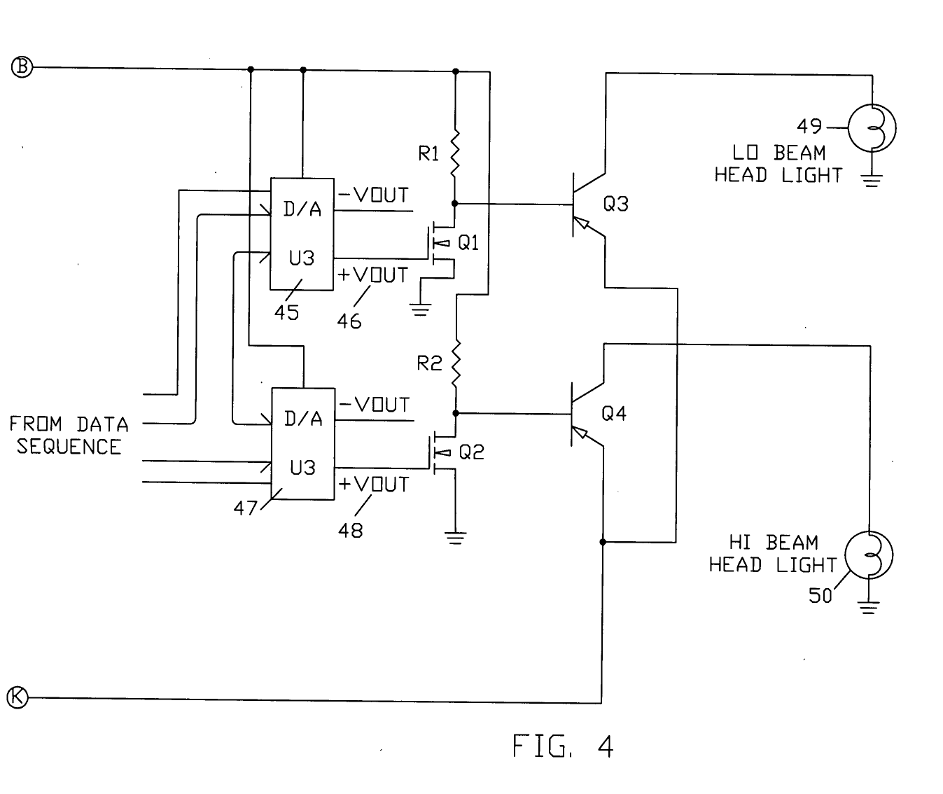

FIG. 4 is the circuit diagram, according to the present invention, that illustrates the implementation of the invention whereby bipolar junction transistors (BJT) serve to control the current that appears through the motor vehicle headlights and the voltage that appears across the motor vehicle headlights. The schematic diagram further illustrates the output port from digital sequencing device, the multi-channel digital to analog converters 45 and 47 with positive output voltage terminals 46 and 48, the base current/voltage control devices Q1 and Q2, the current/voltage control devices Q3 and Q4, the low beam headlights 49, the high beam headlights 50, and the inputs B and L from the corresponding inputs B and L of FIG. 2A. Input B supplies approximately twelve volts from the reversed battery and over voltage protection circuit 16 of FIG. 2A to the multi-channel digital to analog converters 45 and 47 and to the drain resistors R1 and R2 of the base current/voltage control devices Q1 and Q2. Input L supplies approximately twelve volts from the vehicle batter B1 of FIG. 2A to the current/voltage control devices Q3 and Q4. FIG. 4 also illustrates where the life of the motor vehicle headlights can be extended by a preprogrammed digital sequence that either increments or decrements at a given time interval and is applied to the multi-channel digital to analog converters 45 and 47. The multi-channel digital to analog converters 45 and 47 convert the digital sequence to corresponding analog voltage levels. The resulting analog voltage levels are then applied, by means of the positive out voltage terminals 46 and 48 of the multi-channel digital to analog converters 45 and 47, to the gate of the metal oxide semiconductor field effect transistors (MOSFET) base current/voltage control devices Q1 and Q2. The MOSFET base current/voltage control devices Q1 and Q2, serve a dual purpose. First, the gate of Q1 and Q2 serves as a high input impedance buffer between the positive out voltage terminals 46 and 48 and the base of Q3 and Q4, since the power requirement to drive the current/voltage control devices Q3 and Q4 exceeds the rated output power of the positive out voltage terminals 46 and 48. Second, Q1 and Q2 also serve to supply the base current to Q3 and Q4. In order for Q3 and Q4 to conduct the collector-base junction must be reverse biased while the emitter-base junction must be forward biased. When Q1 and Q2 are in the off state the collector-base junction of Q3 and Q4 is reverse biased, however, the base voltage of Q3 and Q4 is equal to the emitter voltage of Q3 and Q4, therefore, the emitter-base junction is in an unbiased state and Q3 and Q4 are in the off state. However, as a positive voltage is progressively applied to the gate Q1 and Q2, by means of the positive out voltage terminals 46 and 48, the impedance across the drain to source channel of Q1 and Q2 is progressively decreased. Since the impedance across the drain to source channel of Q1 and Q2 is progressively decreased, the voltage drop across R1 and R2 is progressively increased, which precipitates a corresponding decrease in the base voltage of Q3 and Q4. The corresponding decrease in the base voltage of Q3 and Q4 serves to forward bias the emitter-base junction. With the emitter-base junction forward biased and the collector-base junction reverse biased Q3 and Q4 transitions from the off state to the on state. As the positive voltage applied to the gate of Q1 and Q2 is increased, the impedance across the drain to source channel of Q1 and Q2 is further decreased, and the corresponding voltage drop across R1 and R2 is further increased, which precipitates a further decrease in the base voltage of Q3 and Q4 and consequently increases in both the base current of Q3 and Q4, by means of Q1 and Q2, and the collector current that appears through the headlights and the collector voltage that appears across the headlights. The current/voltage control devices Q3 and Q4 that are placed between the motor vehicle power source and the low beam and the high beam headlights serve to control the rate of change of the DC current through the headlights and the DC voltage across the headlights, which eliminates the surge currents that occur during the initial power up phase. FIG. 4 further illustrates where the luminosity of the headlights is controlled by a preprogrammed digital value that is applied to the multi-channel digital to analog converters 45 and 47. The multi-channel digital to analog converters 45 and 47 convert these digital values to corresponding analog voltage levels. The resulting analog voltage levels are then applied, by means of the positive out voltage terminals 46 and 48 of the multi-channel digital to analog converters 45 and 47, to the gate of the MOSFET base current/voltage control devices Q1 and Q2. In order for Q3 and Q4 to conduct the collector-base junction must be reverse biased while the emitter-base junction must be forward biased. When Q1 and Q2 are in the off state the collector-base junction of Q3 and Q4 is reverse biased while the base voltage of Q3 and Q4 is equal to the emitter voltage of Q3 and Q4. Therefore, with the base voltage of Q3 and Q4 equal to the emitter voltage of Q3 and Q4, the emitter-base junction is unbiased and Q3 and Q4 are in the off state. However, as the resulting voltage levels are applied to the gate Q1 and Q2, by means of the positive out voltage terminals 46 and 48, the impedance across the drain to source channel of Q1 and Q2 is decreased. Since the impedance across the drain to source channel of Q1 and Q2 is progressively decreased, the voltage drop across R1 and R2 is progressively increased, which precipitates a corresponding decrease in the base voltage of Q3 and Q4. The corresponding decrease in the base voltage of Q3 and Q4 serves to forward bias the emitter-base junction. With the emitter-base junction forward biased and the collector-base junction reverse biased Q3 and Q4 transitions from the off state to the on state. The current/voltage control devices Q3 and Q4 that are placed between the motor vehicle power source and the low beam and the high beam headlights control the current that appears through the headlights and the voltage that appears across the headlights and, in turn, controls the luminosity of either the high beam and the low beam headlights.

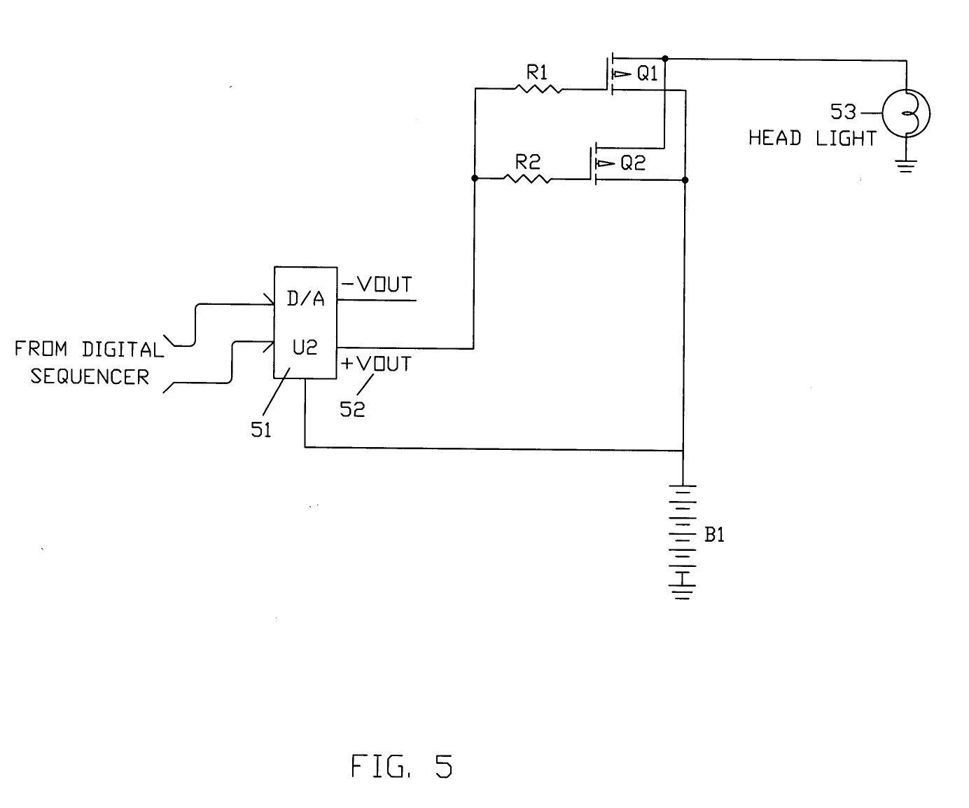

FIG. 5 is the circuit diagram, according to the present invention, that illustrates the implementation of the invention where parallel metal oxide semiconductors field effect transistors serve to extend the life and control the luminosity of the motor vehicle headlights. The schematic diagram further illustrates the output port from the digital sequencing device, the multi-channel digital to analog converter 51, the positive output voltage terminal 52, the current/voltage control devices Q1 and Q2, the motor vehicle headlights 53, the vehicle battery B1, and the gate resistors R1 and R2. The vehicle battery B1 supplies approximately twelve volts to the multi-channel digital to analog converter 51 and to the source terminals of the current/voltage control devices Q1 and Q2. The source terminals, the drain terminals, and the gate terminals of Q1 and Q2 are directly coupled. The coupling of the source terminals, the drain terminals, and the gate terminals of Q1 and Q2 serve to equally divide the current through the headlights and the voltage across the headlights. The resistors R1 and R2 serve to degrade the Q of the LC network formed by the gate-and-drain inductance and capacitance, and therefore eliminate the possibility of self-induced oscillations in the paralleled devices. FIG. 5 also illustrates where the life of the motor vehicle headlights can be extended by a preprogrammed digital sequence that either increments or decrements at a given time interval and is applied to the multi-channel digital to analog converter 51. The multi-channel digital to analog converter 51 converts the digital sequence to a corresponding analog voltage level. The resulting analog voltage level is then applied, by means of the positive out voltage terminal 52 of the multi-channel digital to analog converter 51, to the current/voltage limiting devices Q1 and Q2 which are placed between the motor vehicle power source and the headlights. The current/voltage limiting devices Q1 and Q2, in turn, control the rate of change of the DC current through the headlights and the DC voltage across the headlights, which eliminates the surge currents that occur during the initial power up phase. FIG. 5 further illustrates where the luminosity of the headlights is controlled by a preprogrammed digital value that is applied to the multi-channel digital to analog converter 51. The multi-channel digital to analog converter 51 converts the digital value to a corresponding analog voltage level. The resulting analog voltage level is then applied, by means of the positive out voltage terminals 52 of the multi-channel digital to analog converter 51, to the current/voltage limiting devices Q1 and Q2 that are placed between the motor vehicle power source and the low beam and the high beam headlights. The current/voltage limiting devices Q1 and Q2 control the current that appears through the headlights and the voltage that appears across the headlights and, in turn, control the luminosity of either the high beam or the low beam headlights.

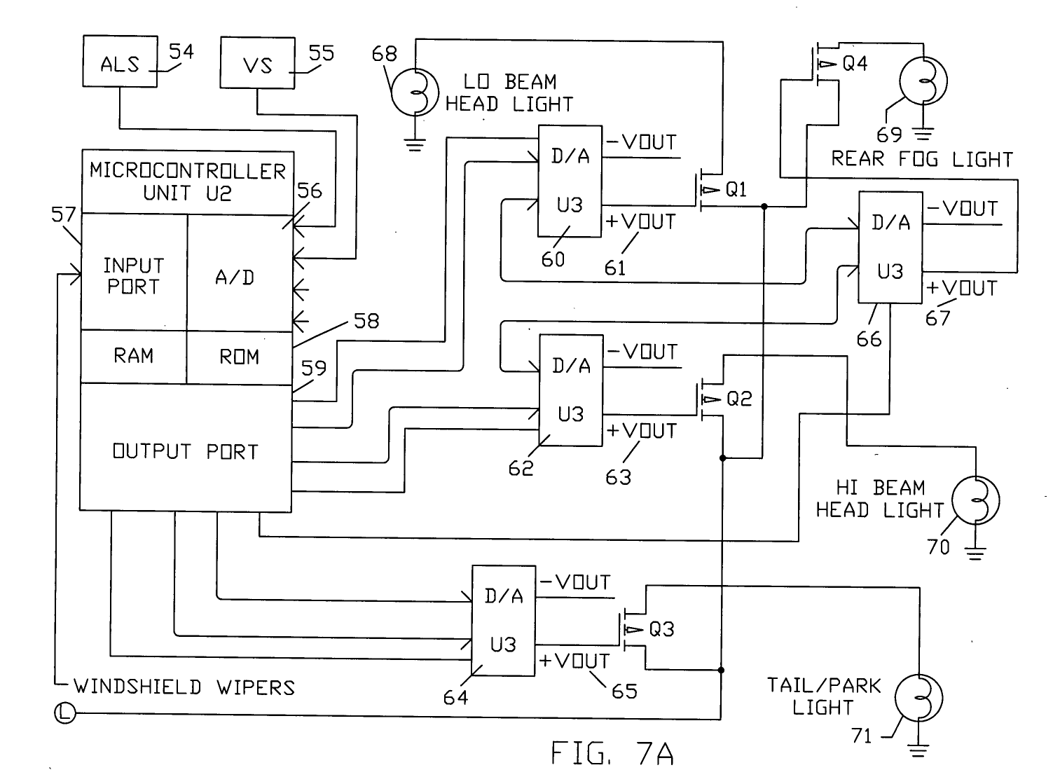

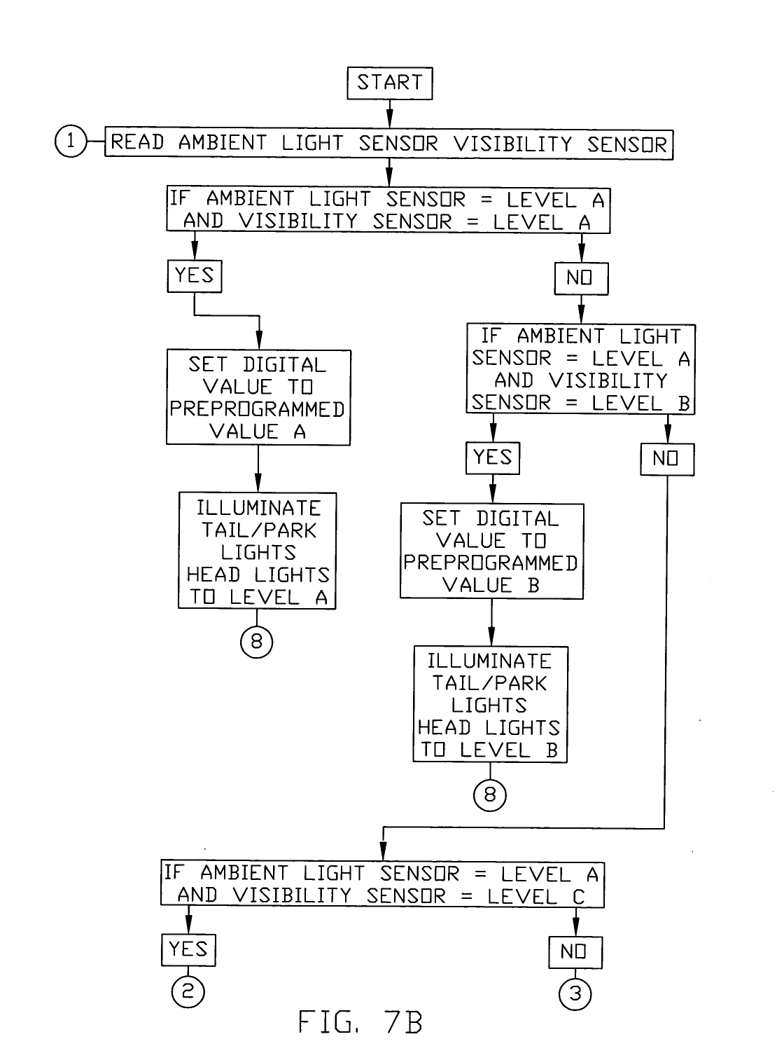

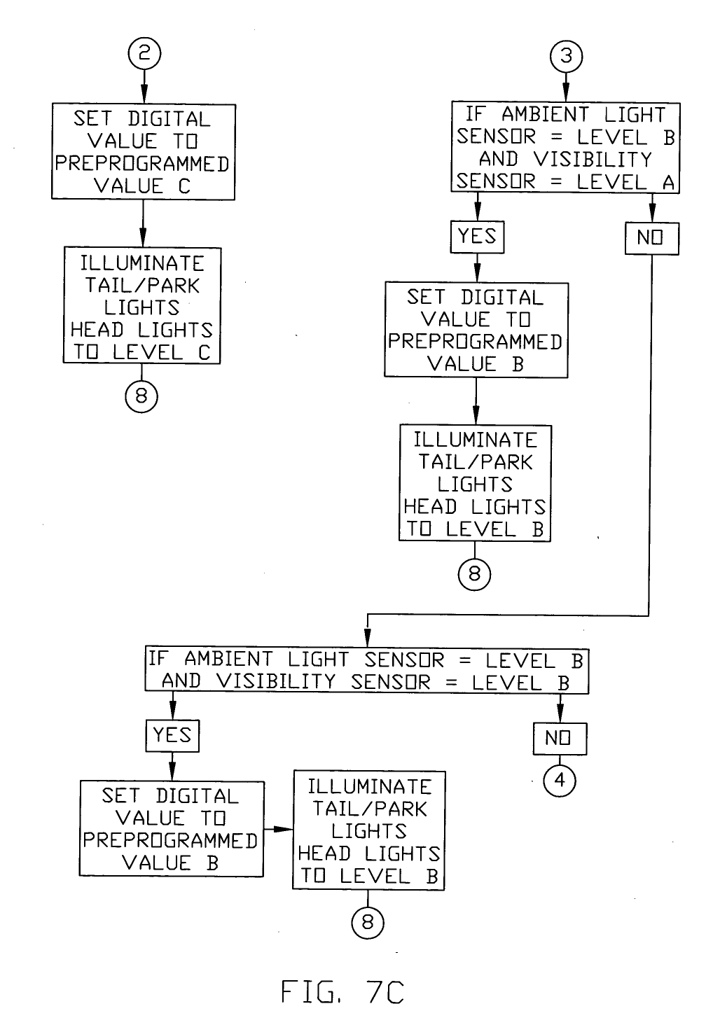

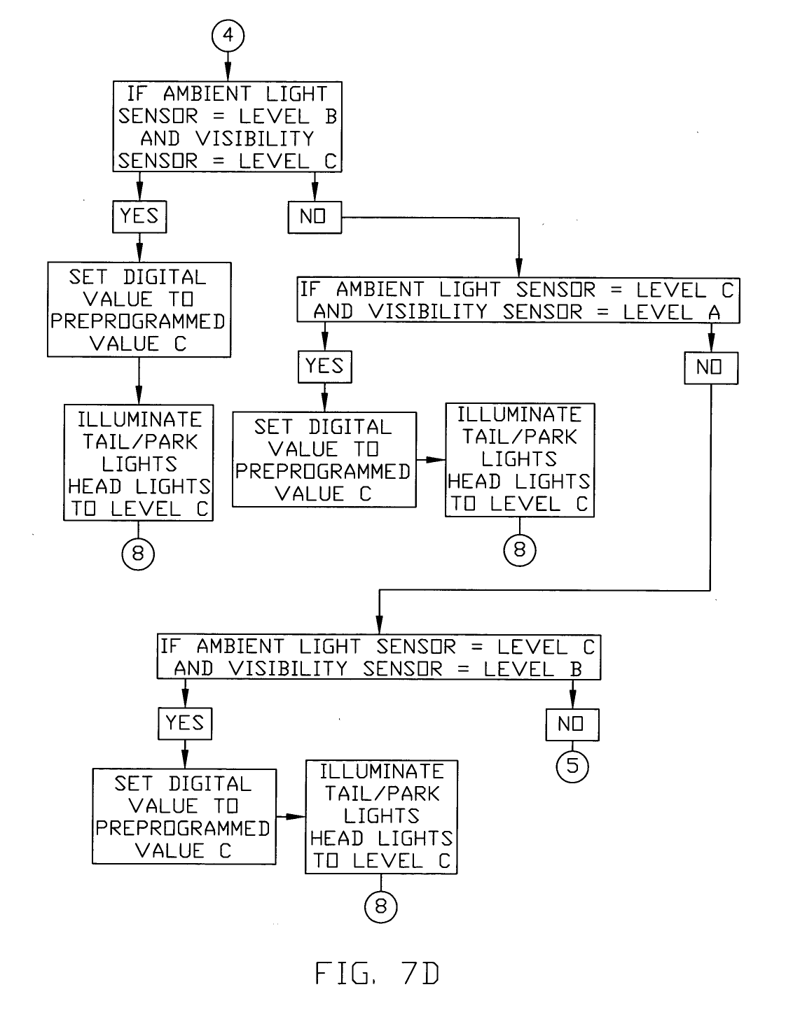

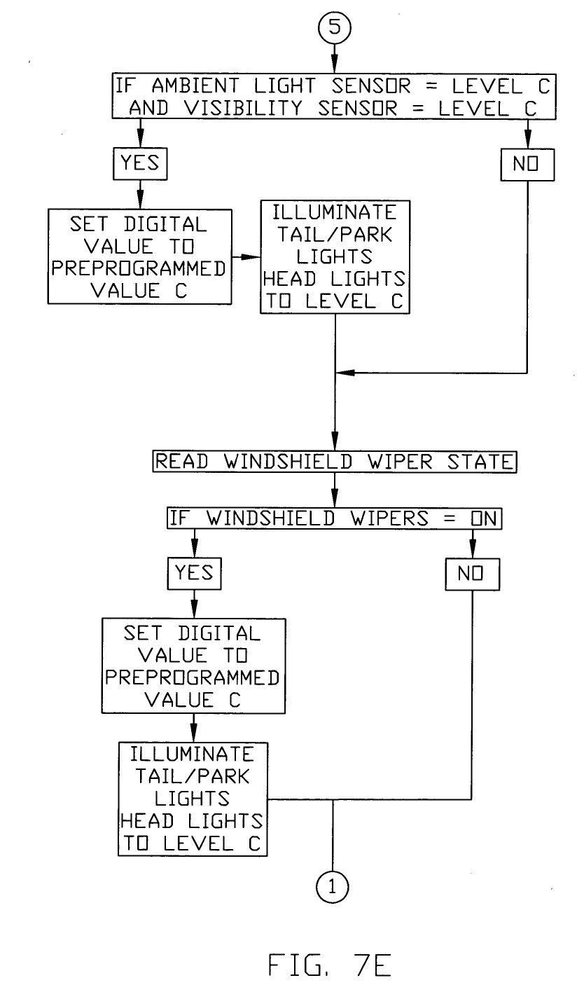

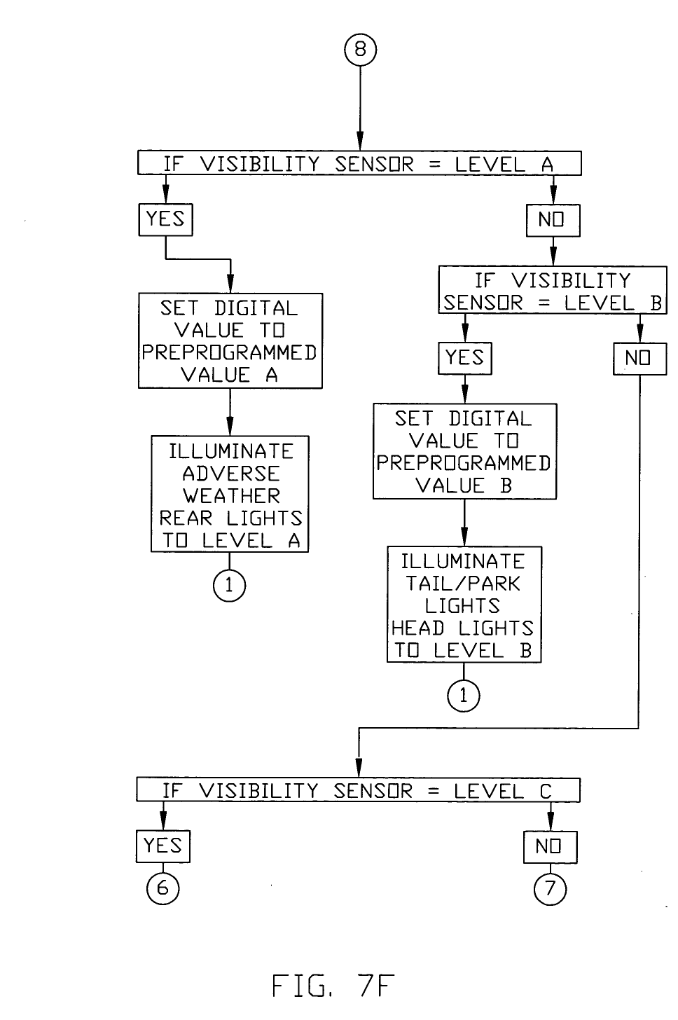

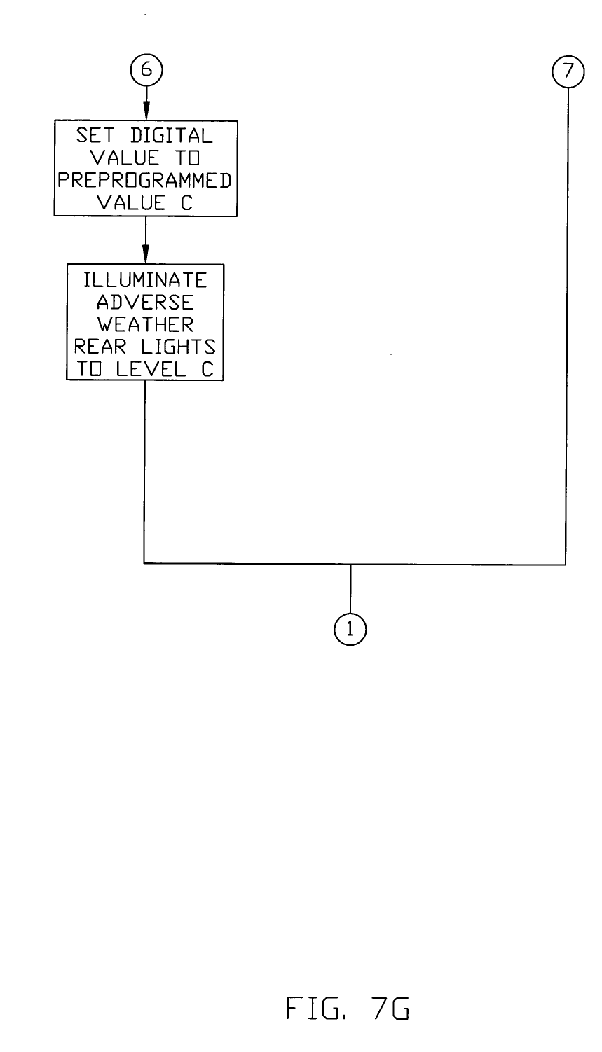

FIG. 6A through FIG. 6C are the general flow charts of the program logic, which resides in the microcontroller ROM: 8 of FIG. 1B, 23 of FIG. 2B, 35 of FIG. 3, and 58 of FIG. 7A. FIG. 6A through FIG. 6C further illustrates the daytime running light embodiment of the invention by means of either the high beam headlights or the low beam headlights. In the first step, the state of the tail/park light switch, the headlight switch, regardless of whether the activation of the tail/park light switch and the headlight switch is either by automatic means or manual means, the hi/lo beam headlight switch, and the fog light switch are recognized. In the second step, if the tail/park light switch and the headlight switch are both in the off state then the tail/park lights, the headlights, and the fog lights are deactivated and the state of the trigger switch is recognized. If the trigger switch is in the on state then the daytime running lights are activated, however, if the trigger switch is in the off state the program returns to the first step whereby the state of the tail/park light switch, the headlight switch, the hi/lo beam headlight switch, and the fog light switch are recognized. However, if the tail/park light switch is in the on state then the third step of the program is executed. In the third step, if the tail/park light switch is in the on state and both the headlight switch and the fog light switch are in the off state then the tail/park lights are activated and both the headlights and the fog lights are deactivated and the state of the trigger switch is recognized. If the trigger switch is in the on state then the daytime running lights are activated and the program returns to the first step whereby the state of the tail/park light switch, the headlight switch, the hi/lo beam headlight switch, and the fog light switch are recognized, otherwise if the trigger switch is in the off state the program returns to the first step whereby the state of the tail/park light switch, the headlight switch, the hi/lo beam headlight switch, and the fog light switch are recognized. However, if the tail/park light switch is in the off state then the fourth step of the program is executed. In the fourth step, if both the tail/park light switch and the headlight switch are in the on state and the hi/lo beam switch is in the low state and the fog light switch is in the off state then both the daytime running lights and the fog lights are deactivated while both the tail/park lights and the low beam headlights are activated and the program returns to the first step whereby the state of the tail/park light switch, the headlight switch, the hi/lo beam headlight switch, and the fog light switch are recognized. However, if the tail/park light switch is in the off state then the fifth step of the program is executed. In the fifth step, if both the tail/park light switch and the headlight switch are in the on state and the hi/lo beam switch is in the high state then both the daytime running lights and the fog lights are deactivated while both the tail/park lights and the high beam head lights are activated and the program returns to the first step whereby the state of the tail/park light switch, the headlight switch, the hi/lo beam headlight switch, and the fog light switch are recognized. However, if the tail/park light switch is in the off state then the sixth step of the program is executed. In the sixth step, if both the tail/park light switch and the fog light switch are in the on state and the headlight switch is in the off state then both the tail/park lights and the fog lights are activated and the state of the trigger switch is then recognized. If the trigger switch is in the on state then the daytime running lights are also activated, however, if the trigger switch is in the off state then the daytime running lights are deactivated and the program returns to the first step whereby the state of the tail/park light switch, the headlight switch, the hi/lo beam headlight switch, and the fog light switch are recognized. However, if the tail/park light switch is in the off state then the seventh step of the program is executed. In the seventh step, if the tail/park light switch, the headlight switch, and the fog light switch are in the on state and the hi/lo beam switch is in the low state then the daytime running lights are deactivated and the tail/park lights, the low beam headlights, and the fog lights are activated. However, if the tail/park light switch is in the off state the program returns to the first step whereby the state of the tail/park light switch, the headlight switch, the hi/lo beam headlight switch, and the fog light switch are recognized.

The art whereby the tail/park lights and the headlights either automatically activate or deactivate in conjunction with the current ambient light conditions or the current visibility conditions, and wherein the luminosity of headlights and the tail/park lights either progressively increases or decreases in conjunction with the current ambient light conditions or the current visibility conditions is well known. Also, known is the art where the adverse weather rear lights (rear fog lights) either automatically activate or deactivate in conjunction with the current visibility conditions, and where the luminosity of the adverse weather rear lights, which is always greater than the luminosity of the tail lights, either progressively increases as the current visibility conditions decrease or progressively decreases as the current visibility conditions increase. Further known is the art where the headlights and the tail/park lights automatically activate in conjunction with the state of the windshield wipers.

FIG. 7A is the schematic diagram, according to the present invention, that illustrates the implementation of the invention whereby the tail/park lights and the headlights either automatically activate or deactivate in conjunction with the current ambient light conditions and wherein the luminosity of headlights and the tail/park lights either progressively increases or decreases in conjunction with the current ambient light conditions. Also, the schematic diagram, according to the present invention, further illustrates whereby the tail/park lights, the headlights, and the adverse weather rear lights (rear fog lights) either automatically activate or deactivate in conjunction with the current visibility conditions, and where the luminosity of the tail/park lights, the headlights, and the adverse weather rear lights, which is always greater than the luminosity of the tail lights, either progressively increases as the current visibility conditions decrease or progressively decreases as the current visibility conditions increase, and whereby the headlights and the tail/park lights automatically activate in conjunction with the state of the windshield wipers. The schematic diagram further illustrates the ambient light sensor 54, the visibility sensor 55, the onboard multi-channel analog to digital converter 56, the input port 57, onboard ROM 58, the output port 59, the multi-channel digital to analog converters 60, 62, 64, and 66 with positive output voltage terminals 61, 63, 65, and 67, the current/voltage control devices Q1, Q2, Q3, and Q4, the low beam headlights 68, the rear fog lights 69, the high beam headlights 70, and the tail/park lights 71. Input L is the corresponding output L, from FIG. 2A, which supplies approximately twelve volts from the vehicle battery B1 of FIG. 2A to the current/voltage control devices Q1, Q2, Q3, and Q4.

FIG. 7A further illustrates where the current ambient light conditions and the current visibility conditions are converted to analog voltage levels by means of the ambient light sensor 54. The analog voltage level from the ambient light sensor 54 is applied to the multi-channel analog to digital converter 56. The multi-channel analog to digital converter 56 converts the analog voltage level to a corresponding digital value. If the current ambient light conditions have decreased to a preprogrammed threshold then a preprogrammed digital value is applied to the multi-channel digital to analog converters 60, 62, and 64 by means of the output port 59. The multi-channel analog to digital converters 60, 62, and 64 converts these digital values to corresponding analog voltage levels. The resulting analog voltage levels are then applied, by means of the positive out voltage terminals 61, 63, and 65 of the multi-channel digital to analog converters 60, 62, and 64 to the current/voltage limiting devices Q1, Q2, and Q3 that are placed between the motor vehicle power source and the low beam headlights, the high beam headlights, and the tail/park lights. The current/voltage limiting devices Q1, Q2, and Q3, in turn, progressively control the current that appears through the headlights and tail/park lights and the voltage that appears across the headlights and tail/park lights. The tail/park lights and the headlights automatically activate and the luminosity of the headlights and the tail/park lights progressively increases as the current ambient light conditions continue to decrease until the tail/park lights and the headlights are at the full luminous level. Likewise, as the current ambient light conditions increase the luminosity of the tail/park lights and the headlights progressively decrease until the current ambient light conditions have increased to a preprogrammed threshold at which time the tail/park lights and the headlights automatically deactivate.

FIG. 7A also illustrates where the current visibility conditions are converted to an analog voltage level by means of the visibility sensor 55. The analog voltage level from the visibility sensor 55 is applied to the multi-channel analog to digital converter 56. The multi-channel analog to digital converter 56 converts the analog voltage level to a corresponding digital value. If the current visibility conditions have decreased to a preprogrammed threshold then a preprogrammed digital value is applied to the multi-channel digital to analog converters 60, 62, 64, and 66 by means of the output port 59. The multi-channel analog to digital converters 60, 62, 64, and 66 convert the digital values to corresponding analog voltage levels. The resulting analog voltage levels are then applied, by means of the positive out voltage terminals 61, 63, 65, and 67 of the multi-channel digital to analog converters 60, 62, 64, and 66 to the current/voltage limiting devices Q1, Q2, Q3, and Q4 that are placed between the motor vehicle power source and the tail/park lights, the headlights, and the adverse weather rear lights. The current/voltage limiting devices Q1, Q2, Q3, and Q4, in turn, progressively controls the current that appears through the tail/park lights, the headlights, and the adverse weather rear lights and the voltage that appears across the tail/park lights, the headlights, and the adverse weather rear lights. Therefore, the tail/park lights, the headlights, and the adverse weather rear lights either automatically activate or deactivate in conjunction with the current visibility conditions, and the luminosity of the tail/park lights, the headlights, and the adverse weather rear lights either progressively increases as the current visibility conditions decrease and progressively decreases as the current visibility conditions increase.

FIG. 7A also illustrates whereby the headlights and the tail/park lights automatically activate in conjunction with the state of the windshield wipers. This embodiment serves to comply with the law of those states that require the activation of the tail/park lights and the headlights in conjunction with the windshield wipers. The state of the windshield wipers is established by means of the input port 57 and if the windshield wipers are in the active state then a preprogrammed digital value is applied to the multi-channel digital to analog converters 60, 62, and 64 by means of the output port 59. The multi-channel analog to digital converters 60, 62, and 64 converts these digital values to corresponding analog voltage levels. The resulting analog voltage levels are then applied, by means of the positive out voltage terminals 61, 63, and 65 of the multi-channel digital to analog converters 60, 62, and 64 to the current/voltage limiting devices Q1, Q2, and Q3 that are placed between the motor vehicle power source and the tail/park lights and the headlights. The current/voltage limiting devices Q1, Q2, and Q3, in turn, activate the tail/park lights and the headlights at the full luminous level.

FIG. 7B through FIG. 7G are the general flow charts of the program logic, which resides in the microcontroller ROM: 8 of FIG. 1B, 23 of FIG. 2B, 35 of FIG. 3, and 58 of FIG. 7A. FIG. 7B through FIG. 7G further illustrates the embodiment of the invention whereby the tail/park lights, the headlights, and the adverse weather rear lights either automatically activate or deactivate in conjunction with the current visibility conditions. Furthermore, FIG. 7B through FIG. 7G illustrates where the luminosity of headlights, the tail/park lights, and the adverse weather rear lights either progressively increases or decreases in conjunction with the current visibility conditions. Also, FIG. 7B through FIG. 7G further illustrates whereby the headlights and the tail/park lights automatically activate in conjunction with the state of the windshield wipers. In the first step, the current ambient light conditions and the current visibility conditions are established by means of the ambient light sensor and the visibility sensor. In the second step, if the current ambient light condition and the current visibility condition is equal to level A then the preprogrammed digital value is set to A which illuminates the tail/park lights, the headlights and the adverse weather rear lights to level A, whereby the luminosity of level A for the adverse weather rear lights is greater than the luminosity of level A for the tail lights, and returns to the first step where the current ambient light condition and the current visibility condition is established by means of the ambient light sensor and the visibility sensor. However, if the current ambient light conditions and the current visibility conditions are not equal to level A then the third step of the program is executed. In the third step, if the current ambient light condition is equal to level A and the current visibility condition is equal to level B then the preprogrammed digital value is set to B which illuminates the tail/park lights, the headlights, and the adverse weather rear lights to level B, whereby the luminosity of level B for the adverse weather rear lights is greater than the luminosity of level B for the tail lights, and the program returns to the first step where the current ambient light conditions and the current visibility conditions are established by means of the ambient light sensor and the visibility sensor. However, if the current ambient light condition is not equal to level A and the current visibility condition is not equal to level B then the fourth step of the program is executed. In the fourth step, if the current ambient light condition is equal to level A and the current visibility condition is equal to level C then the preprogrammed digital value is set to C which illuminates the tail/park lights, the headlights, and the adverse weather rear lights to level C, whereby the luminosity of level C for the adverse weather rear lights is greater than the luminosity of level C for the tail lights, and the program returns to the first step where the current ambient light conditions and the current visibility conditions are established by means of the ambient light sensor and the visibility sensor. However, if the current ambient light condition is not equal to level A and the current visibility condition is not equal to level C then the fifth step of the program is executed. In the fifth step, if the current ambient light condition is equal to level B and the current visibility condition is equal to level A then the preprogrammed digital value for the tail/park lights and the headlights is set to level B, while the preprogrammed digital value for the adverse weather rear lights is set to level A, and the program returns to the first step where the current ambient light and the current visibility conditions are established by means of the ambient light sensor and the visibility sensor. However, if the current ambient light condition is not equal to level B and the current visibility condition is not equal to level A then the sixth step of the program is executed. In the sixth step, if the current ambient light condition and the current visibility condition is equal to level B then the preprogrammed digital value is set to B which illuminates the tail/park lights, the headlights, and the adverse weather rear lights to level B, whereby the luminosity of level B for the adverse weather rear lights is greater than the luminosity of level B for the tail lights, and the program returns to the first step where the current ambient light conditions and the current visibility conditions are established by means of the ambient light sensor and the visibility sensor. However, if the current ambient light condition and the current visibility condition is not equal to level B then the seventh step of the program is executed. In the seventh step, if the current ambient light condition is equal to level B and the current visibility condition is equal to level C then the preprogrammed digital value is set to C, which illuminates the tail/park lights, the headlights, and the adverse weather rear lights to level C, whereby the luminosity of level C for the adverse weather rear lights is greater than the luminosity of level C for the tail lights, and the program returns to the first step where the current ambient light conditions and the current visibility conditions are established by means of the ambient light sensor and the visibility sensor. However, if the current ambient light condition is not equal to level B and the current visibility condition is not equal to level C then the eighth step of the program is executed. In the eighth step, if the current ambient light condition is equal to level C and the current visibility condition is equal to level A then the preprogrammed digital value for the tail/park lights and the headlights is set to level C, while the preprogrammed digital value for the adverse weather rear lights is set to level A and the program returns to the first step where the current ambient light conditions and the current visibility conditions are established by means of the ambient light sensor and the visibility sensor. However, if the current ambient light condition is not equal to level C and the current visibility condition is not equal to level A then the ninth step of the program is executed. In the ninth step, if the current ambient light condition is equal to level C and the current visibility condition is equal to level B then the preprogrammed digital value for the tail/park lights and the headlights is set to level C while the preprogrammed digital value for the adverse weather rear lights is set to level B and the program returns to the first step where the current ambient light conditions and the current visibility conditions are established by means of the ambient light sensor and the visibility sensor. However, if the current ambient light condition is not equal to level C and the current visibility condition is not equal to level B then the tenth step of the program is executed. In the tenth step, if the current ambient light condition and the current visibility condition is equal to level C then the preprogrammed digital value is set to C which illuminates the tail/park lights, the headlights, and the adverse weather rear lights to level C, whereby the luminosity of level C for the adverse weather rear lights is greater than the luminosity of level C for the tail lights, and the program returns to the first step where the current ambient light conditions and the current visibility conditions are established by means of the ambient light sensor and the visibility sensor. However, if the current ambient light condition is not equal to level C and the current visibility condition is not equal to level C then the eleventh step of the program is executed. In the eleventh step, the state of the windshield wipers is recognized. In the twelfth step, if the windshield wipers are in the on state then the preprogrammed digital value is set to level C which illuminates the tail/park lights and the headlights to level C. The program returns to the first step whereby the current ambient light conditions and the current visibility conditions are established by means of the ambient light sensor and the visibility sensor. However, if the windshield wipers are in the off state the program returns to the first step whereby the current ambient light and the current visibility conditions are established by means of the ambient light sensor and the visibility sensor.

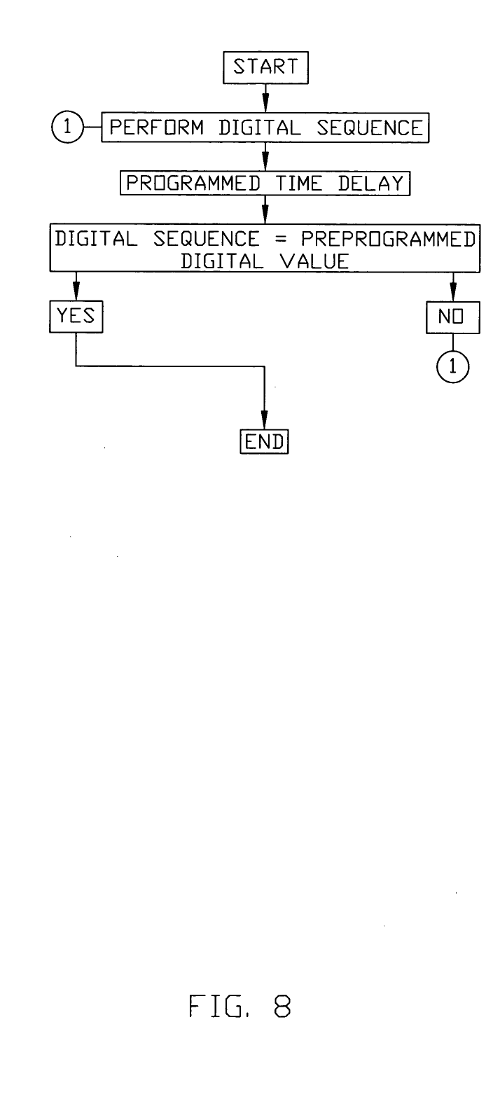

FIG. 8 is the general flow chart of the program logic, which resides in the microcontroller ROM: 8 of FIG. 1B, 23 of FIG. 2B, 35 of FIG. 3, and 58 of FIG. 7A. FIG. 8 further illustrates whereby the life of the motor vehicle tail/park lights and the headlights is extended by the control of the initial surge currents through the light filaments during the initial power up phase. In the first step, the digital sequence either increments or decrements. In the second step, the preprogrammed delay is executed. In the third step, the value of the digital sequence if compared to the preprogrammed digital value and if the digital sequence is equal to the preprogrammed digital value then the program concludes otherwise the program returns to the digital sequence either increments or decrements.

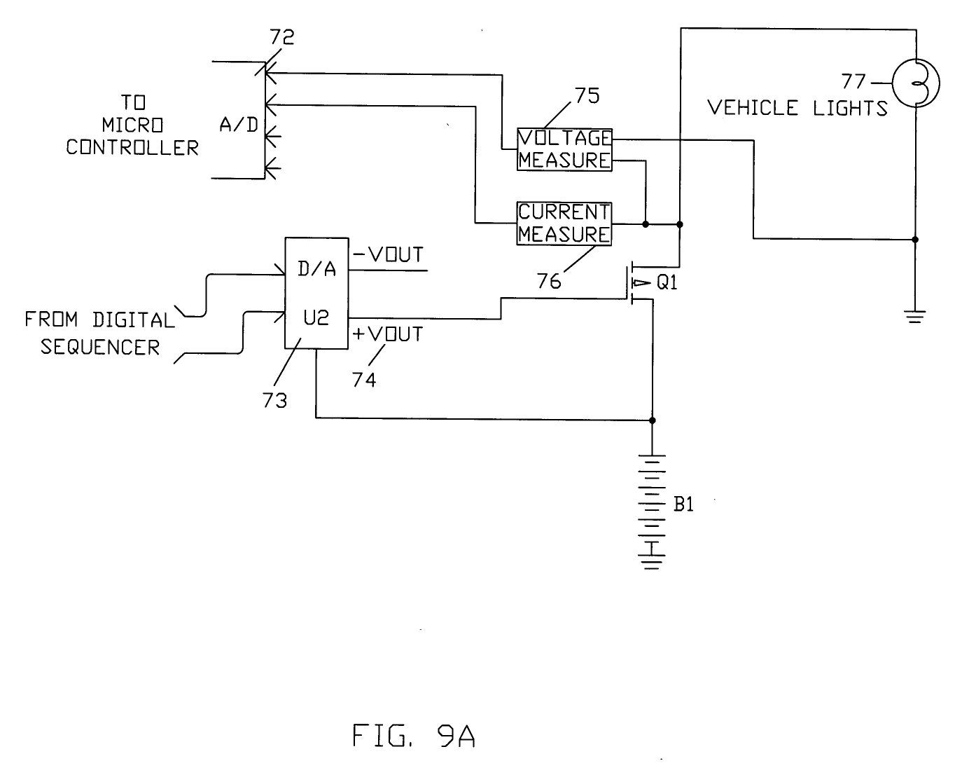

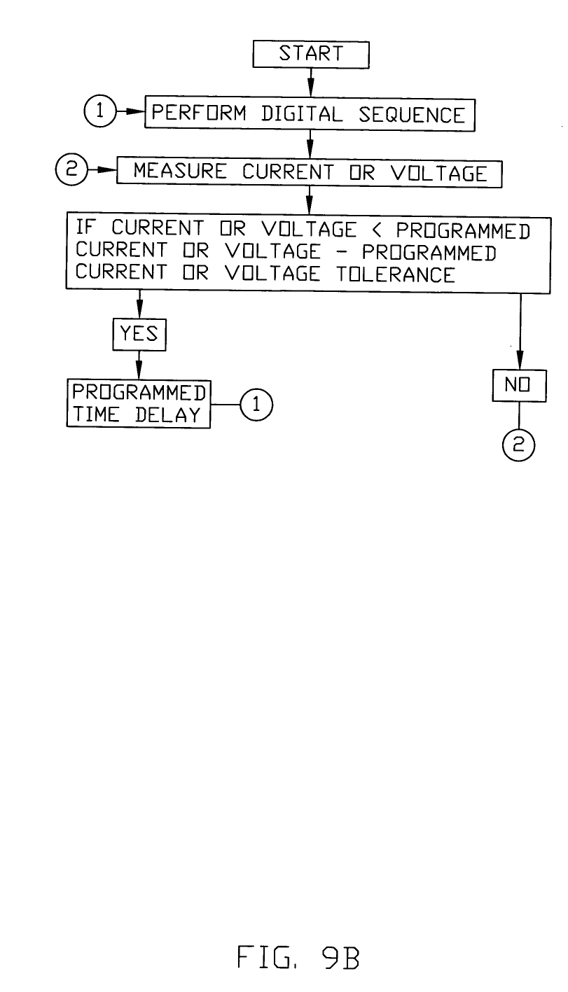

FIG. 9A is the circuit diagram, according to the present invention, that illustrates the negation of the normalized on resistance versus the temperature characteristics of the current/voltage control devices, and activate a fault indicator if the current/voltage level is either greater than or less than the programmed current/voltage level where the luminosity of motor vehicle lights operate at a reduced luminous level. The dynamic increase in the junction temperature effectuated by the power that is dissipated by the current/voltage control device precipitates a corresponding dynamic increase in the on resistance. The dynamic increase in the on resistance precipitates a corresponding dynamic decrease in the luminosity of the headlights or any other motor vehicle lights. FIG. 9A further illustrates the digital inputs from the digital sequencing device to the digital input of the drive circuit device 73, the analog output from the drive circuit device 74 to the gate of the current/voltage limiting device Q1, the means to measure the DC current through the lights 76, the means to measure the DC voltage across the lights 75, the multi-channel analog to digital converter 72, the motor vehicle lights 77, and the vehicle battery B1. The vehicle battery B1 supplies approximately twelve volts to the multi-channel digital to analog converter 73 and to the source terminal of the current/voltage control device Q1. The preprogrammed digital sequence that either increments or decrements at a given time interval and is applied to the multi-channel digital to analog converter 73. The multi-channel digital to analog converter 73 converts the digital sequence to a corresponding analog voltage level. The resulting analog voltage level is then applied, by means of the positive out voltage terminal 74 of the multi-channel digital to analog converter 73, to the current/voltage limiting device Q1 which is placed between the motor vehicle power source and the motor vehicle lights. The current/voltage limiting device Q1, in turn, controls the rate of change of the DC current through the motor vehicle lights and/or the DC voltage across the motor vehicle lights. The current-measuring device and/or the voltage-measuring device, measures the DC current through the motor vehicle lights and/or the DC voltage across the motor vehicle lights, and converts the DC current through the motor vehicle lights and/or the DC voltage across the motor vehicle lights to an analog voltage level. The resulting analog current level and/or the analog voltage level is then applied, by means of the current-measuring device and/or the voltage-measuring device, to the multi-channel analog to digital converter 72 where it is converted from an analog value to a corresponding digital value and compared to the preprogrammed current level and/or voltage level. The preprogrammed digital sequence continues to either increment or decrement, at a given time interval, until either the DC current through the motor vehicle lights and/or the DC voltage across the motor vehicle lights is equal to the preprogrammed current level and/or the preprogrammed voltage level ± the preprogrammed current tolerance and/or the preprogrammed voltage tolerance.

FIG. 9B is the general flow chart of the program logic, which resides in the microcontroller ROM: 8 of FIG. 1B, 23 of FIG. 2B, 35 of FIG. 3, and 58 of FIG. 7A. FIG. 9B further illustrates the negation of the normalized on resistance versus the temperature characteristics of the current/voltage control devices and maintains the luminosity of the headlights or any other motor vehicle lights at an unvarying level, where an unprogrammed variation in the luminosity of the headlights or any other motor vehicle lights is disadvantageous in applications where the luminosity of motor vehicle lights operate at a reduced luminous level. The program logic, which is an embedded function within the main program logic, measures the DC current through the motor vehicle lights and/or the DC voltage across the motor vehicle lights. In the first step, the digital sequence is performed. In the second step, the current-measuring device and/or the voltage-measuring device measures the DC current through the motor vehicle lights and/or the DC voltage across the motor vehicle lights. If the DC current through the motor vehicle lights and/or the DC voltage across the motor vehicle lights is less than the preprogrammed current level and/or voltage level ± the preprogrammed current tolerance and/or the preprogrammed voltage tolerance, the program proceeds to the preprogrammed time delay and then performs the digital sequence. However, if the DC current through the motor vehicle lights and/or the DC voltage across the motor vehicle lights is equal to the preprogrammed current level and/or the preprogrammed voltage level ± the preprogrammed current tolerance and/or the preprogrammed voltage tolerance, the program returns to the second step that measures the DC current through the motor vehicle lights and/or the DC voltage across the motor vehicle lights.

It is understood that the application of the invention is not limited to the specific embodiments shown, that the scope of the invention applies to all DC lights. It is further understood that a digital sequencing means collectively encompasses all means that are capable of generating a digital sequence to include, however, not limited to, counters, microcontrollers, and microprocessors. Furthermore, any person who is skilled in the art or science should be aware that suitable filtering must be incorporated in the circuit design and that consideration must also be given to the dissipation of heat for the current/voltage control devices.

1. A system to control the luminosity of a motor vehicle lamp comprising:
a digital sequencing means for the initiation of a digital value;
a drive circuit means for the conversion of the digital value to an analog voltage level;
a current/voltage control means for the control of the current through a motor vehicle lamp and the voltage across the motor vehicle lamp.

2. A system to control the luminosity of a motor vehicle lamp and negate the normalized on resistance versus the junction temperature characteristics of the current/voltage control means and the impedance variation of the motor vehicle lamps, and thereby maintain the motor vehicle lamps at an unvarying luminosity level comprising:
a current measurement means to measure the current through the motor vehicle lamp and/or a voltage measurement means to measure the voltage across the motor vehicle lamp.

3. The system to control the luminosity of a motor vehicle lamp and negate the normalized on resistance versus the junction temperature characteristics of the current/voltage control means and the impedance variation of the motor vehicle lamps according to claim 2 whereby the current measurement means and/or the voltage measurement means activates a fault indication means if the current level and/or the voltage level is either greater than or less than the programmed current/voltage level.

4. A system to extend the life of a motor vehicle lamp comprising:
a digital sequencing means for the initiation of a digital sequence and whereby the digital sequence either increments or decrements, as required, at a given time interval;
a drive circuit means for the conversion of the digital sequence to an analog voltage level;
a current/voltage control means for the control of the current through a motor vehicle lamp and the voltage across the motor vehicle lamp.

5. The system to extend the life of a motor vehicle lamp according to claim 4 further comprising a means to store the digital sequence and the time interval that the digital sequence either increments or decrement, furthermore where the time interval between when the digital sequence either increments or decrements can be of one value for t=0 to t=1, a second value at t=1 to t=2, and a third value at t=2 to t=3.
